(19) United States
(12) Patent Application Publication
(10) Pub. No.: US 2005/0019496 A1
(43) Pub. Date: Jan. 27, 2005

(54) Method for preparation of metal wire rod for use in plastic working

(76) Inventors: Masayuki Yoshida, Atsugi-shi (JP); Shinobu Komiyama, Atsugi-shi (JP); Yugo Tsuiki, Hiratsuka-shi (JP)

Correspondence Address: HENKEL CORPORATION, THE TRIAD, SUITE 200, 2200 RENAISSANCE BLVD., GULPH MILLS, PA, 19406, US

(21) Appl. No.: 10/827,174

(22) Filed: Apr. 19, 2004

Related U.S. Application Data
(63) Continuation of application No. PCT/JP02/10750, filed on Oct. 16, 2002.

(30) Foreign Application Priority Data
Oct. 19, 2001 (JP) 2001-322574

(51) Int. Cl. B05D 3/12

(52) U.S. Cl. 427/299; 427/372.2

(57) ABSTRACT

The invention provides a method for the inline manufacturing of metal wire rod for use in plastic working with excellent lubricity, thereby providing energy, space and time savings, wherein the surface of metal wire rod cleaned by shot blasting, sand blasting, bending, anodic pickling, and cathodic pickling or the like for 20 seconds or less; contacted with an aqueous, lubricating-coating formation processing liquid containing inorganic salt and at least one kind of lubricant for 5 seconds or less, and then dried immediately to form a lubricant film with a coating weight of 0.5-20 g/m2 on the surface of said metal rod, all in a continuous inline system.

### CROSS-REFERENCE TO RELATED APPLICATIONS

This application claims priority from International Application Number PCT/JP02/10750, published in a non-English language, having an international filing date of Oct. 16, 2002, and to JP 2001-322574 filing date Oct. 19, 2001.

### FIELD OF THE INVENTION

The present invention relates to an inline-system manufacturing method for manufacturing metal wire rod for use in plastic working, which provides excellent lubricity to the surface of the substrate metal wire rod such as iron, steel, stainless steel, titanium, aluminum, etc., without carrying out chemical conversion treatment or coating. To be more specific, the present invention pertains to a new process for forming, in an inline system, a coating film having excellent lubricity on the surface of metal wire rod such as iron, steel, stainless steel, titanium, aluminum, etc, without the need for conversion coating, suitable for cold plastic working, such as heading or header processing.

### BACKGROUND OF THE INVENTION

During the plastic working of a substrate metal such as steel or stainless steel, a lubricious coating film is usually formed on the surface of the substrate metal in order to prevent burn-on, sticking, scoring or fouling as the result of metal contact between the substrate material and the tool. Examples of such lubricious coating films include the type of film formed by the physical adhering of a lubricant on the metal surface and the type of film formed by applying a lubricant after forming a chemical conversion coating on the metal surface. Generally, the adhesion of the films formed by the physical adhering of a lubricant on the metal surface is inferior to the adhesion of films formed by applying a lubricant after forming a chemical conversion coating on the metal surface, and thus the former is generally used for light processing.

In the film formed by applying a lubricant after the chemical formation of a conversion coating on the metal surface, it is customary to apply a lubricant with slippery characteristics after the formation of a phosphate film or an oxalate film. A coating film of this type forms a two-layer structure consisting of the conversion coating, which serves as a carrier, and a coating film with lubricity, and provides a high level of protection against fouling, in particular burning and sticking. For these reasons, coatings of this kind have been used widely in the field of plastic working such as wire drawing, tube drawing, deep drawing, pipe drawing, casting or forging, etc. Particularly in the field of plastic working under especially harsh processing conditions, the method of forming an undercoat such as a phosphate film, an oxalate film, etc., on the metal surface first, and then applying a lubricant is frequently used.

The lubricants used on a conversion coating can be divided into two types depending on how they are used, i.e., the type of lubricants that physically adhere to the conversion coating and the type of lubricants that adhere to the conversion coating by means of chemical reactions. Lubricants belonging to the former group include those formed by adding an extreme-pressure additive to a base oil such as mineral oil, a plant oil, or a synthetic oil, and those that are obtained by dissolving and/or dispersing a solid lubricant, such as graphite, molybdenum disulfide, etc., together with a binder component, and are used in adhesion and drying processes. These lubricants are advantageous because they can be used simply and conveniently by a spray coating or immersion coating technique and because almost no liquid management is required. However, their lubricity is low and thus they are used mostly in processes that require only relatively light lubrication. In contrast, a reactive soap such as sodium stearate is used in the latter lubricants, and thus they can be used in processes that require high lubricity.

When a conversion film-forming process accompanied by chemical reactions and a reactive soap are used, high lubricity can be obtained but liquid management, temperature management for controlling the chemical reaction, and discarding and regenerating processes due to deterioration of the liquid become necessary. Reducing the amount of industrial waste has become an important task in recent years from the standpoint of global environmental protection. Therefore, the use of lubricants and processing methods that will produce few if any waste products is desirable. In addition, the management of liquid processing in conventional techniques is complex, so the development of a simple and convenient processing method would be desirable.

In the known lubrication treatment of metal wire rod, the strand formed by winding the wire rod into a coil is treated using batch processing, that is a discontinuous format. In general, a strand of about 2 tons is immersed in a processing tank with a capacity of several tens of tons or thereabouts to carry out the processing. Usually, after removing oily materials by alkaline degreasing and water rinsing, the strand is subjected to acid cleaning and pickling by immersion in a tank of hydrochloric acid or sulfuric acid to remove scale. The temperature at this time is in the range of standard (room) temperature to 60° C. and the immersion time is usually several tens of minutes. Next, water rinsing, immersion in a conversion tank, and phosphate film processing or oxalate film processing is carried out. In the case of phosphating, the processing temperature is about 80° C. and the immersion time is about 10 minutes. Thereafter, the strand is water rinsed and immersed in a soap-processing tank. The soap processing temperature is about 80° C. and the processing time is about 10 minutes. As mentioned above, conventional processing is carried out in a batch format and several tanks of several tens of tons capacity are needed. The large capacity tanks require larger manufacturing sites. Also, a large quantity of energy is required to raise the tanks to the necessary temperature and maintain the temperature. In addition, the processing time for each step in the process is long. For example, the overall time required to completely process one strand is about an hour.

In order to overcome the problems mentioned above, lubricant compositions obtained by blending a solid lubricant and a conversion coating film-forming agent in an aqueous emulsion as the base have been developed (Japanese patent Publication No. 52[1977]-20,967), but none of them compare favorably with individual conversion coating film-forming agents. In order to solve the aforementioned problems, the inventors of the present invention developed aqueous lubricants for use in the cold plastic working of metals. These lubricants were formed by uniformly dispersing and emulsifying a solid lubricant and an oil by blending (A) a water-soluble inorganic salt, (B) a solid lubricant, (C) at least one oil component selected from the group consisting of mineral oils, animal and plant oils, and synthetic oils, (D) a surfactant, and (E) water (Japanese Patent Publication No. 10[1998]-8,085). However, such lubricants are not stable for industrial use because an oil component is emulsified in them. Therefore, high lubricity cannot be produced in a stable fashion.

In order to overcome the problems mentioned above, the inventors of the present invention also developed lubricant compositions for use in the plastic working of metal materials (Japanese Patent Publication No. 2000-63,880). They are formed by dissolving or dispersing (A) a synthetic resin and (B) an aqueous inorganic salt in water, wherein the solid matter weight ratio of (A) to (B) is set within the range of 0.25/1 to 9/1. In the lubricants formed in the present invention, synthetic resins are used as the main component and thus they could not produce thorough lubricity under harsh processing conditions. Moreover, although a description regarding lubricity is given in this Patent Publication, a sufficient description regarding the continuous inline processing of wire rod is not provided.

The present invention was developed to solve the problems encountered in the conventional technique. The object of the present invention is to provide a manufacturing method for metal wire rod for use in plastic working with excellent lubricity. This manufacturing method takes global environmental protection into consideration, can shorten the manufacturing time, is energy saving and space saving, and is applicable to a variety of metal wire rods.

### SUMMARY OF THE INVENTION

The inventors of the present invention carried out extensive studies in order to develop means for solving the problems mentioned above and were able to develop a new inline manufacturing method, as described below. In this continuous process, the surface of the metal wire rod for use in plastic working was initially subjected to a specific cleaning treatment, brought into contact with an aqueous processing solution containing specified components, and then dried. Rather, that performing these steps in a batchwise manner, these processes were carried out continuously to obtain metal wire rod with its surface coated with a lubricant film with a specific coating weight.

Namely, the present invention pertains to a method of manufacturing metal wire rod for use in plastic working comprising cleaning metal wire rod having a diameter of 0.3-50 mm by at least one cleaning process for 20 seconds or less; the cleaning process being selected from the group comprising shot blasting, sand blasting, bending, anodic pickling, and cathodic pickling. The cleaned metal wire rod is then brought into contact, for 5 seconds or less, with an aqueous, lubricating-coating formation processing liquid containing at least one kind of inorganic salt selected from the group consisting of phosphates, sulfates, borates, silicates, molybdates, and tungstates, and at least one kind of lubricant selected from the group consisting of metal soaps, waxes, polytetrafluoroethylene, molybdenum disulfide, and graphite, in which the solid matter weight ratio of said lubricant to inorganic salt is set within a range of 0.1 to 4.0. The metal wire rod is then dried immediately to form a lubricant film with a coating weight of 0.5-20 g/m2 on the surface of said metal wire rod in a continuous inline system. Metal wire rod for use as the aforementioned substrate metal wire rod is preferably selected from the group consisting of iron, steel, stainless steel, aluminum, aluminum alloy, magnesium, magnesium alloy, titanium, titanium alloy, copper, and copper alloy. Moreover, the line speed of the metal wire rod during continuous processing is preferably in the range of 10 to 150 m/minute.

In the above mentioned method, the cleaning treated metal wire rod can be contacted with the aqueous lubricious film formation treating solution after preheating by means of heating methods such as high frequency heating, hot air heating, hot water heating, steam heating, direct heating or superheated steam heating.

### BRIEF DESCRIPTION OF THE DRAWINGS

FIG. 1 is a cross sectional diagram of a bolt obtained when the metal wire rod for use in plastic working manufactured by the method of the present invention was tested for heading workability.

### DETAILED DESCRIPTION OF A PREFERRED EMBODIMENT

The present invention will now be described in more detail in accordance with the following preferred embodiments. Metal wire rod prepared by the manufacturing method of the present invention can be used for cold plastic working. The cold plastic working mentioned here mainly refers to cold heading. Cold heading in general is used, for example, for manufacturing bolts. In addition, automobile or machine parts are also manufactured by the cold working of material cut from said rod.

Metal wire rod in accordance with the present invention is used for the cold working described above and preferably consists of a commonly used metal selected from the group comprising iron/steel, stainless steel, aluminum, aluminum alloy, magnesium, magnesium alloy, titanium, titanium alloy, copper, and copper alloy. In accordance with the present invention, the metal wire rod is processed not in the strand state in a bundled or coiled form (the aforementioned batch format processing), but instead in an inline format, where the loose individual wire rod is processed continuously and consecutively. Thus, the processing times disclosed herein will be understood by those of ordinary skill in the art to be directed to the residence time of a particular point on the loose individual wire rod in the cleaning, coating and drying treatments.

The diameter (rod diameter) of the metal wire rod is preferably in the range of 0.3 to 50 mm. When the rod diameter is less than 0.3 mm, the rod will be too fine to be coated uniformly by the method of the present invention and problems may be encountered in the subsequent plastic working in some cases. A rod diameter of greater than 50 mm will not cause specific technical problems, but it is industrially impractical because of the difficulty encountered in winding or taking up the rod.

The cleaning process used for the metal wire rod is desirably selected from the group comprising, preferably consisting of shot blasting, sand blasting, bending, anodic pickling, and cathodic pickling. The object of the cleaning mentioned above is to remove the oxidized scale that forms as the result of annealing, etc., as well as various contaminants (oils, etc.). This cleaning process will allow the subsequent lubricant film formation to proceed smoothly. The reduction in the wastewater processing load is especially desirable from the standpoint of the environmental problems of recent years. For this, so-called mechanical descaling, a method that produces no wastewater, namely, inline shot blasting or bending, is useful. Moreover, when an acid is used, anodic pickling or cathodic pickling utilizing electrolysis can be used to shorten the processing time. For anodic pickling, an acid such as sulfuric acid is used. The wire rod is used as the anode and a counterelectrode (platinum plate, etc.) is used as the cathode to carry out electrolysis for several seconds under an applied voltage of 2-50 V and a current density of 2-100 A/dm2 to cause part of the metal substrate to melt for the simultaneous removal of scale. For cathodic pickling, an acid such as sulfuric acid is used. The wire rod is used as the cathode and a counterelectrode (platinum plate, etc.) is used as the anode to carry out electrolysis for several seconds under an applied voltage of 2-50 V and a current density of 2-100 A/dm2; the force of the hydrogen gas that evolves from the metal surface is utilized to remove the scale.

In the case of heavy scale, it is effective to subject the wire rod to cathodic pickling after anodic pickling. The combined use of cathodic and anodic pickling is effective for removing fine residues (blast powders, etc.) that are not easily removed by mechanical descaling. After anodic pickling and/or cathodic pickling, the surface is cleaned and the acid is rinsed off with water. In the present invention, it is desirable to limit the cleaning process time to less than 20 seconds. When the processing time exceeds 20 seconds, the inline treatment zone tends to become too long and the space saving objective of the present invention cannot be realized.

In the present invention, after the metal wire rod is cleaned, as described above, the rod is contacted with an aqueous lubricant-coating formation processing liquid. Before the contact with this aqueous lubricant-coating formation processing liquid, it is desirable to preheat the metal wire rod. By this preheating, the time for drying can be shortened, because drying of the aqueous lubricant-coating formation processing liquid is accelerated by application to a rod preheated to a higher temperature.

By way of non-limiting example, specific methods for this preheating include high frequency heating, hot air heating, hot water heating, steam heating, direct heating or superheated steam heating. This preheating is carried out such that the temperature of the metal wire rod is raised to approximately 70° C.-150° C. When the temperature of the metal wire rod us less than 70° C., it is difficult to accelerate the drying of the lubricious coating. When the temperature of the metal wire rod exceeds 150° C., normal lubricious film cannot be formed due to generation of vapor when the 150° C. rod contacts the aqueous lubricant-coating formation processing liquid. The effect of shortening the drying time by preheating provides the added benefit of allowing reduction of the amount of space used for the treating equipment, since an inline continuous process requires a certain length of treatment tank for a given treatment time.

The aqueous lubricant-coating formation processing liquid contains inorganic salts and lubricants as its main components. The lubricant film of the present invention must show good plastic workability, good follow-up properties, hardness, and resistance to burning and sticking with the mold or die, a good slipping property, and be capable of reducing the coefficient of friction.

In order to achieve these goals, it is important to use an inorganic salt in combination with the lubricant. The inorganic salt is preferably at least one kind of inorganic salt selected from the group consisting of phosphates, sulfates, borates, silicates, molybdates, and tungstates. More specifically, these inorganic salts include, for example, zinc phosphate, calcium phosphate, sodium sulfate, potassium sulfate, potassium silicate, sodium borate (sodium tetraborate), potassium borate (potassium tetraborate, etc.), ammonium borate (ammonium tetraborate, etc.), ammonium molybdate, sodium molybdate, sodium tungstate, etc. They can be used individually or in combinations of 2 or more.

The preferred lubricants include metal soaps, waxes, fluorocarbon resins such as polytetrafluoroethylene (PTFE), molybdenum disulfide, and graphite. They can be used singly or in combinations of 2 or more. In more detail, the metal soaps can be obtained by reacting a C12-C26 saturated fatty acid with at least one kind of metal selected from the group consisting of zinc, calcium, barium, aluminum, magnesium, and lithium. They include, for example, calcium stearate, zinc stearate, barium stearate, magnesium stearate, lithium stearate, etc. The waxes include, for example, microcrystalline wax, polyethylene wax, polypropylene wax, carnauba wax, etc. There are no particular limitations with regard to the average particle diameter or molecular weight of the PTFE, molybdenum disulfide, or graphite.

The blending ratio of the lubricant and the inorganic salt contained in the lubricating-coating formation processing liquid in terms of the solid matter weight ratio of the lubricant to the inorganic salt is desirably set within a range 0.1 to 4.0. When this solid matter weight ratio is less than 0.1, the slipping property will become poor and sufficient lubricity cannot be obtained. A ratio greater than 4.0 is not desirable because crush flaws will form easily during working. An even more preferable range for the weight ratio is 0.2 to 1.5. The lubricant and the inorganic salt are used in the form of an aqueous processing liquid obtained by dissolving and/or dispersing them in water. In this case, a well recognized surfactant or stabilizer could be used to stabilize the dispersion. When it is necessary to use a surfactant, any one of the group consisting of nonionic surfactants, anionic surfactants, amphoteric surfactants, and cationic surfactants may be used.

There are no particular limitations with regard to the nonionic surfactants mentioned above. For example, polyoxyethylene alkyl ethers, polyoxyalkylene (ethylene and/or propylene) alkyl phenyl ethers, polyoxyethylene alkyl esters consisting of polyethylene glycol (or ethylene oxide) and a higher fatty acid (for example, those containing 12-18 carbon atoms), polyoxyethylene sorbitan alkyl esters consisting of sorbitan, polyethylene glycol, and a higher fatty acid (for example, those containing 12-18 carbon atoms), etc., may be used. There are no particular limitations with regard to the anionic surfactants that can be used. For example, they include fatty acid salts, sulfate esters, sulfonates, phosphate esters, dithiophosphate esters, etc. There are no particular limitations with regard to the amphoteric surfactants that can be used. For example, they include carboxylic acid salts of the amino acid type and betaine type, sulfate esters, sulfonates, phosphate esters, etc. There are no particular limitations with regard to the cationic surfactants that can be used. For example, they include fatty acid amine salts, quaternary ammonium salts, etc. These surfactants may be used individually or in combinations of two or more.

Furthermore, if needed, a well-recognized thickening agent may be added to the lubricating-coating formation processing liquid to assist film formation. For example, a thickening agent is effective in improving smoothness and suppressing flaws in the film. A polymer may also be added as a binder component in order to improve the tightness of adhesion. There are no particular limitations with regard to the amount and type of such substances added. For example, clay minerals of the inorganic smectite system (montmorillonite, saponite, beidellite, hectorite, etc.) and polymers in the organic system such as the urethane type (polyols and polyisocyanate polymers, etc.), polycarbonate type (polymers of acrylic acid, methacrylic acid, maleic acid, itaconic acid, etc.), polyolefin type (polyvinyl alcohol, etc.), polyether type (polyethylene glycol, polypropylene glycol, etc.), and polysaccharides (methyl cellulose, methyl starch, methyl guar gum, etc.) may be used.

In the present invention, it is desirable to limit the time of contact with the aqueous lubricating-coating formation processing liquid to no more than 5 seconds. Contact times of more than 5 seconds are not desirable because the inline treatment zone will become too long and the space- saving objective of the present invention cannot be realized. The coating weight of the lubricant film is desirably within the range of 0.5 to 20 g/m2. When the coating weight is less than 0.5 g/m2, sufficient lubricity cannot be obtained; and a coating weight of greater than 20 g/m2 is not desirable because the film can become too thick and crush flaws or unwanted slag may form. The coating weight of the lubrication film can be adjusted to the specified coating weight by controlling the amount and concentration of the lubricant being coated. The coating weight can be determined simply as follows: The processed wire rod is cut to a desired length and its weight is determined. The film is then peeled off and the weight difference is determined. The coating weight can be calculated from the weight difference and the surface area (calculated from the cutoff length).

In the present invention, wire rod that has been coated with the lubricating-coating formation processing liquid is immediately dried to form a lubricant film on the wire rod surface. There are no particular limitations with regard to the method used for drying, but hot air drying works well and is advantageous because it is simple and convenient. After the drying process, the wire rod can be taken up by a reel or can be continuously subjected to wire drawing, skin-pass rolling, or heading. The line speed for continuous processing of the metal wire rod of the present invention is preferably in a range of 10- 150 m/min. A line speed of less than 10 m/minute is industrially useless because sufficient productivity cannot be achieved. At line speeds of greater than 150 m/minute, the uniformity of the lubricant film after the coating process tends to become deteriorated.

The following Examples are presented as specific illustrations of the claimed invention. It should be understood, however, that the invention is not limited to the specific details of the Examples.

### EXAMPLES

### Substrate (Wire Rod)

\mathring{1} Substrate steel for drawing (S45C spheroidized material); diameter 3 mm, length 20 m

\mathring{2} Stainless steel material for drawing (SUS 430); diameter 3 mm, length 20 m

\mathring{3} Titanium material for drawing (β-alloy, Ti-15V-3Cr-3Sn-3Al); diameter 3 mm, length 20 m

\mathring{4} Steel material for bolt forming (SCM 435); diameter 9 mm, length 300 m

### Lubricating-Coating Formation Processing Liquid

Processing Liquid 1

| Inorganic Salt: | sodium tetraborate |
|---|---|
| Lubricant: | sodium stearate |
| Lubricant/Inorganic Salt Ratio: | 1.0 |
| Solid Matter Concentration: | 10% |

Processing Liquid 2

| | |
|---|---|
| Inorganic Salt: | zinc phosphate + sodium |
| | tetraborate (weight ratio 1:2) |
| Lubricant: | zinc stearate + calcium |
| | stearate (weight ratio 1:1) |
| Lubricant/Inorganic Salt Ratio: | 0.5 |
| Solid Matter Concentration: | 5% |

Processing Liquid 3

| | |
|---|---|
| Inorganic Salt: | sodium tetraborate |
| Lubricant: | microcrystalline wax |
| Lubricant/Inorganic Salt Ratio: | 2.0 |
| Solid Matter Concentration: | 8% |

Processing Liquid 4

| | |
|---|---|
| Inorganic Salt: | calcium sulfate + sodium |
| | tetraborate (weight ratio 1:1) |
| Lubricant: | PTFE |
| Lubricant/Inorganic Salt Ratio: | 0.3 |
| Solid Matter Concentration: | 15% |

Processing Liquid 5

| | |
|---|---|
| Inorganic Salt: | calcium silicate |
| Lubricant: | calcium stearate + polyethylene |
| | wax (weight ratio 1:2) |
| Lubricant/Inorganic Salt Ratio: | 1.5 |
| Solid Matter Concentration: | 20% |

Processing Liquid 6

| | |
|---|---|
| Inorganic Salt: | sodium tetraborate |
| Lubricant: | none |
| Lubricant/Inorganic Salt Ratio: | 0 |
| Solid Matter Concentration: | 10% |

Processing Liquid 7

| | |
|---|---|
| Inorganic Salt: | none |
| Lubricant: | polyethylene wax |
| Lubricant/Inorganic Salt Ratio: | ∞ |
| Solid Matter Concentration: | 10% |

Processing Liquid 8

| | |
|---|---|
| Inorganic Salt: | sodium tetraborate |
| Lubricant: | sodium stearate |
| Lubricant/Inorganic Salt Ratio: | 1.0 |
| Solid Matter Concentration: | 0.5% |

### Examples 1-3

The aforementioned substrate (wire rod) was subjected to the processing steps \mathring{1} through \mathring{5} described below, sequentially according to the number. The line speed for processing was 40 m/minute.

\mathring{1} Anodic Pickling: sulfuric acid 20%, temperature 60° C., time 1 second, current density 30 A/dm².

\mathring{2} Cathodic Pickling: sulfuric acid 20%, temperature 60° C., time 4 seconds, current density 40 A/dm².

\mathring{3} Water Rinsing: tap water, 60° C., immersion 5 seconds

\mathring{4} Surface Processing: the aforementioned processing liquid 1 ( Example 1), processing liquid 2 ( Example 2) or processing liquid 3 ( Example 3) was used; 60° C., immersion 2 seconds.

\mathring{5} Drying: 140° C., 15 seconds (hot air blowing)

### Examples 4-5

The aforementioned substrate (wire rod) was subjected to the processing steps \mathring{1} through \mathring{3} described below, sequentially according to the number. The line speed for processing was 40 m/minute.

\mathring{1} Shot Blasting: spherical shot (Ø0.5 mm), time 10 seconds, pressure 5 kgf/cm²

\mathring{2} Surface Processing: processing liquid 4 (Example 4) or processing liquid 5 (Example 5) mentioned above was used; 60° C., immersion 3 seconds

\mathring{3} Drying: 140° C., 15 seconds (hot air blowing)

### Examples 6-8

The aforementioned substrate (wire rod) was subjected to the processing steps \mathring{1} through \mathring{5} described below, sequentially according to the number. The line speed for processing was 100 m/minute.

\mathring{1} Bending: 90° bending (4 steps)

\mathring{2} Cathodic Pickling: sulfuric acid 20%, temperature 60° C., time 2 seconds, current density 100 A/dm².

\mathring{3} Water Rinsing: tap water, 60° C., immersion 3 seconds

\mathring{4} Surface Processing: processing liquid 1 ( Example 6), processing liquid 2 ( Example 7), or processing liquid 3 (Example 8) mentioned above was used; 60° C., immersion 1 second

\mathring{5} Drying: induction heating (2 seconds), temperature reached: 120° C.

### Examples 9-10

The aforementioned substrate (wire rod) was subjected to the processing steps \mathring{1} through \mathring{4} described below, sequentially according to the number. The line speed for processing was 40 m/minute.

\mathring{1} Shot Blasting: spherical shot (Ø0.5 mm), time 10 seconds, pressure 5 kgf/cm²

\mathring{2} Preliminary heating: Hot water bath (90° C.), immersion 3 seconds

\mathring{3} Surface Processing: Processing liquid 4 ( Example 9) or processing liquid 5 (Example 10) mentioned above was used; 60° C., immersion 1 second

\mathring{4} Drying: 140° C., 3 seconds (hot air blowing)

### Examples 11-12

The aforementioned substrate (wire rod) was subjected to the processing steps \mathring{1} through \mathring{4} described below, sequentially according to the number. The line speed for processing was 100 m/minute.

\mathring{1} Shot Blasting: spherical shot (Ø0.5 mm), time 5 seconds, pressure 7 kgf/cm²

\mathring{2} Preliminary heating: Induction heating, 1 second reached a temperature of 80° C.

\mathring{3} Surface Processing: Processing liquid 4 ( Example 11) or processing liquid 5 (Example 12) mentioned above was used; 60° C., immersion 1 second

\mathring{4} Drying: 200° C., 2 seconds (hot air blowing)

### Comparison Examples 1-2

The aforementioned substrate (wire rod) was subjected to the processing steps \mathring{1} through \mathring{5} described below, sequentially according to the number. The line speed for processing was 40 m/minute.

\mathring{1} Anodic Pickling: sulfuric acid 20%, temperature 60° C., time 1 second, current density 30 A/dm².

\mathring{2} Cathodic Pickling: sulfuric acid 20%, temperature 60° C., time 4 seconds, current density 40 A/dm².

\mathring{3} Water Rinsing: tap water, 60° C., immersion 5 seconds

\mathring{4} Surface Processing: the aforementioned processing liquid 6 (Comparison Example 1) or processing liquid 7 (Comparison Example 2) was used; 60° C., immersion 2 seconds.

\mathring{5} Drying: 140° C., 15 seconds (hot air blowing)

### Comparison Example 3

The aforementioned substrate (wire rod) was subjected to the processing steps \mathring{1} and \mathring{2} described below, sequentially according to the number. The line speed for processing was 40 m/minute.

\mathring{1} Surface Processing: processing liquid 1 mentioned above was used; 60° C., immersion 3 seconds

\mathring{2} Drying: 140° C., 15 seconds (hot air blowing)

### Comparison Example 4

The aforementioned substrate (wire rod) was subjected to the processing steps \mathring{1} through \mathring{3} described below, sequentially according to the number. The line speed for processing was 200 m/minute.

\mathring{1} Shot Blasting: spherical shot (Ø0.5 mm), time 10 seconds, pressure 5 kgf/cm²

\mathring{2} Surface Processing: processing liquid 8 was used, 60° C., immersion 3 seconds

\mathring{3} Drying: 140° C., 15 seconds (hot air blowing)

### Comparison Example 5

The aforementioned substrate (substrate steel \mathring{1}, \mathring{4}) was subjected to the processing steps \mathring{1} through \mathring{8} described below, sequentially according to the number.

\mathring{1} Alkaline Degreasing: commercial degreasing agent (registered trademark Fine Cleaner 4360, a product of Nihon Parkerizing Co., Ltd), concentration 20 g/L, temperature 60° C., immersion 10 minutes

\mathring{2} Water Rinsing: tap water, standard temperature, immersion 5 minutes.

\mathring{3} Acid Rinsing: 17% hydrochloric acid, temperature 30° C., immersion 10 minutes.

\mathring{4} Water Rinsing: tap water, standard temperature, immersion 5 minutes.

\mathring{5} Conversion Processing: commercial zinc phosphate conversion processing agent (registered trademark Palbond 3670 X, a product of Nihon Parkerizing Co. Ltd.)

\mathring{6} Water Rinsing: tap water, standard temperature, immersion 5 minutes.

\mathring{7} Soap Processing: commercial reactive soap lubricant (registered trademark Palube 235, a product of Nihon Parkerizing Co., Ltd.), concentration 70 g/L, 80° C., immersion 5 minutes.

\mathring{8} Drying: 80° C., 20 minutes.

### Comparison Example 6

The aforementioned substrate (substrate steel \mathring{2}) was subjected to the processing steps \mathring{1} through \mathring{8} described below, sequentially according to the number.

\mathring{1} Alkaline degreasing: commercial degreasing agent (registered trademark Fine Cleaner 4360, a product of Nihon Parkerizing Co., Ltd), concentration 20 g/L, temperature 60° C., Palube 4649C, a product of Nihon Parkerizing Co., Ltd.), concentration 800 g/L, 80° C., immersion 3 minutes.

\mathring{8} Drying: 80° C., 20 minutes.

Various metal wire rods obtained from Examples 1-12 and Comparison Examples 1-7 were evaluated as described below and the results obtained are listed in Table 1.

Evaluation

Drawing Workability: The wire rod was subjected to drawing in 3 steps under the conditions described below. The flaws detected during the third drawing step and the drawing load (kgf) in the third step were evaluated. The heavier the load without flaws the better.
1st step: Ø3.00 mm→Ø2.76 mm
2nd step: Ø2.76 mm→Ø2.40 mm
3rd step: Ø2.40 mm→Ø2.17 mm

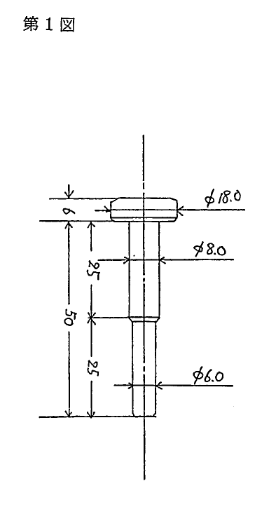

Heading: The wire rod for bolt forming was subjected to skin pass rolling (to Ø8.3 mm). 2,000 bolts were then prepared continuously with the use of an existing header machine and former oil as shown in FIG. 1. The presence or absence of flaws on the front part was determined by the naked eye and the number and extent of the flaws were examined.

Number of Processing Steps: Evaluation was based on the number of processing steps and the area occupied by the facilities. It is more desirable to have fewer processing steps and a smaller area occupied by the installation.

Environmental Protection: Evaluation was based on the presence or absence of discarded industrial waste materials (slag). The absence of slag is desirable.

TABLE 1

| | | | | En- | | | | | | | | |
|---|---|---|---|---|---|---|---|---|---|---|---|---|
| | Film | | | viron- | Drawing | | Drawing process | | Drawing | | | |
| | ad- | | | mental | process | | (stainless | | process | | Header | |
| | hering | Process | | pro- | (steel) | | steel) | | (titanium) | | process | |
| | amount | numbers of | space | tection | | load | | load | | load | imperfection | |
| | (g/m³) | process | (m²) | sludge | imperfection | (Kgf) | imperfection | (Kgf) | imperfection | (Kgf) | (nos.) | remarks |
| Example 1 | 10 | 5 | 15 | no | no | 150 | no | 200 | no | 190 | 0 | good |
| Example 2 | 3 | 5 | 15 | no | no | 152 | no | 210 | no | 195 | 0 | good |
| Example 3 | 5 | 5 | 15 | no | no | 153 | no | 195 | no | 185 | 0 | good |
| Example 4 | 15 | 3 | 10 | no | no | 149 | no | 198 | no | 190 | 0 | good |
| Example 5 | 18 | 3 | 10 | no | no | 150 | no | 200 | no | 185 | 0 | good |
| Example 6 | 10 | 5 | 12 | no | no | 149 | no | 205 | no | 190 | 0 | good |
| Example 7 | 3 | 5 | 12 | no | no | 153 | no | 210 | no | 195 | 0 | good |
| Example 8 | 5 | 5 | 12 | no | no | 151 | no | 200 | no | 195 | 0 | good |
| Example 9 | 15 | 4 | 7 | no | no | 151 | no | 202 | no | 195 | 0 | good |
| Example 10 | 18 | 4 | 7 | no | no | 150 | no | 200 | no | 188 | 0 | good |
| Example 11 | 15 | 4 | 15 | no | no | 148 | no | 199 | no | 185 | 0 | good |
| Example 12 | 18 | 4 | 15 | no | no | 148 | no | 202 | no | 190 | 0 | good |
| Co. Example 1 | 10 | 3 | 10 | no | yes | 190 | yes | 250 | yes | 250 | NG* | NG |
| Co. Example 2 | 10 | 3 | 10 | no | yes | 200 | yes | 250 | yes | 250 | NG* | NG |
| Co. Example 3 | 10 | 2 | 6 | no | yes | 190 | yes | 235 | yes | 230 | 180 | NG |
| Co. Example 4 | 0.3 | 3 | 10 | no | yes | 200 | yes | 250 | yes | 250 | NG* | imperfection |
| Co. Example 5 | 10 | 8 | 100 | yes | no | 155 | — | — | — | — | 0 | good |
| Co. Example 6 | 10 | 8 | 100 | yes | — | — | no | 200 | — | — | — | — |
| Co. Example 7 | 10 | 8 | 100 | yes | — | — | — | — | no | 190 | — | — |

*Scoring is generated from the starting. Test is stopped after several pieces is processed

TABLE KEY: (a) Example . . . ; (b) Comparison Example . . . ; (c) film; (d) coating weight, g/m2; (e) processing; (f) number of processing steps; (g) occupied area, m2; (h) environmental protection; (i) slag; (j) drawing (steel); (k) flaw(s); (l) load, kgf; (m) drawing (stainless steel); (n) drawing (titanium); (o) heading; (p) flaw(s) (no. of rods); (q) remarks; (r) none; (s) present; (t) good; (u) poor; and (v) flaws in the entire area. (*)Fouling occurred from the beginning. The test was discontinued after processing several rods.

It can be seen from Table 1 that Examples 1-12, in which the manufacturing method of the present invention for the metal wire rod for use in plastic working, produced lubricity and showed excellent space saving and environmental protection. In the case of Examples 9 and 10, since the time necessary for the entire process can be shortened by preheating the metal wire rod, the space required for the treating equipment can be reduced.

In the case of Examples 11 And 12, although the treating speed is 2.5 times that of Examples 4 and 5, the space required for the treating equipment is only 1.5 times that of Examples 4 and 5. This is attributed to the shortened treating time resulting from preheating.

In Comparison Examples 1 and 2, in which the lubricant/inorganic salt ratio was out of the range of the present invention, the lubricity was poor and partial fouling with the die occurred at the time of drawing; and no heading was possible. In Comparison Example 3 without the cleaning process, the lubricity was insufficient and further processing was impossible. In Comparison Example 4 with the coating weight out of the range, the lubricity was also insufficient. In Comparison Examples 4-7, in which the conventional technique was used, the lubricity was good but problems regarding processing space and environmental protection were present.

The explanation given above indicates that when the manufacturing method of the present invention for metal wire rod for use in plastic working is used, a film coating with high lubricity can be formed simply and conveniently in a short time. Furthermore, its industrial application value is very high from the standpoint of environmental protection and also from the standpoint of energy savings and space savings.

Although the invention has been described with reference to preferred embodiments, it is to be understood that variations and modifications may be resorted to as will be apparent to those skilled in the art. Such variations and modifications are to be considered within the purview and scope of the claims appended hereto.

1. A method of manufacturing metal wire rod for use in plastic working comprising:
a. cleaning metal wire rod by at least one cleaning process for 20 seconds or less;
b. contacting the metal wire rod with an aqueous, lubricating-coating formation processing liquid comprising:
i. at least one inorganic salt, and
ii. at least one lubricant, wherein the solid matter weight ratio of said lubricant to said inorganic salt is within the range of 0.1 to 4.0, for 5 seconds or less,
c. forming a lubricant film on the metal wire rod by drying the metal wire rod immediately after step (b);
wherein all steps are in a continuous inline system.

2. The method of manufacturing metal wire rod for use in plastic working of claim 1 further comprising the step of pre-heating the metal wire rod prior to contacting with the aqueous, lubricating-coating formation processing liquid in step (b).

3. The method of manufacturing metal wire rod for use in plastic working of claim 1 wherein the inorganic salt is selected from the group consisting of phosphates, sulfates, borates, silicates, molybdates, and tungstates.

4. The method of manufacturing metal wire rod for use in plastic working of claim 3 wherein the lubricant is selected from the group consisting of metal soaps, waxes, poly-tetrafluoroethylene, molybdenum disulfide, and graphite.

5. The method of manufacturing metal wire rod for use in plastic working of claim 4 wherein the lubricant film has a coating weight of 0.5-20 g/m².

6. The method of manufacturing metal wire rod for use in plastic working according to claim 5, wherein the metal wire rod has a diameter of 0.3-50 mm.

7. The method of manufacturing metal wire rod for use in plastic working according to claim 1, wherein the line speed for continuous processing of the metal wire rod is in the range of 10-150 m/minute.

8. The method of manufacturing metal wire rod for use in plastic working according to claim 4, wherein the aqueous, lubricating-coating formation processing liquid further comprises one or more surfactants selected from the group consisting of nonionic surfactants, anionic surfactants, amphoteric surfactants, and cationic surfactants.

9. The method of manufacturing metal wire rod for use in plastic working according to claim 5, wherein the solid matter weight ratio of said lubricant to said inorganic salt is within the range of 0.2 to 1.5.

10. The method of manufacturing metal wire rod for use in plastic working of claim 1, wherein the at least one cleaning process is selected from the group consisting of shot blasting, sand blasting, bending, anodic pickling, and cathodic pickling.

11. The method of manufacturing metal wire rod for use in plastic working of claim 1, wherein said metal wire rod is metal selected from the group consisting of iron, steel, stainless steel, aluminum, aluminum alloy, magnesium, magnesium alloy, titanium, titanium alloy, copper, and copper alloy.

12. The method of manufacturing metal wire rod for use in plastic working according to claim 11, wherein the line speed for continuous processing of the metal wire rod is in the range of 10-150 m/minute.

13. A method of manufacturing metal wire rod for use in plastic working comprising:
cleaning, coating and drying said metal wire rod in a continuous inline system, said system comprising the steps of:
a. cleaning metal wire rod by at least one cleaning process for 20 seconds or less;
b. preheating the metal wire rod and contacting said metal wire rod with an aqueous, lubricating-coating formation processing liquid comprising:
i. at least one inorganic salt selected from the group consisting of phosphates, sulfates, borates, silicates, molybdates, and tungstates, and
ii. at least one lubricant selected from the group consisting of metal soaps, waxes, poly-tetrafluoroethylene, molybdenum disulfide, and graphite, for 5 seconds or less,
c. forming a lubricant film with a coating weight of 0.5-20 g/m² on the metal wire rod by drying the metal wire rod immediately after step (b).

14. The method of manufacturing metal wire rod for use in plastic working according to claim 13, wherein the metal wire rod has a diameter of 0.3-50 mm.

15. The method of manufacturing metal wire rod for use in plastic working according to claim 13, wherein the line speed for continuous processing of the metal wire rod is in the range of 10-150 m/minute.

16. The method of manufacturing metal wire rod for use in plastic working according to claim 13, wherein the aqueous, lubricating-coating formation processing liquid further comprises one or more surfactants selected from the group consisting of nonionic surfactants, anionic surfactants, amphoteric surfactants, and cationic surfactants.

17. The method of manufacturing metal wire rod for use in plastic working according to claim 13, wherein the solid matter weight ratio of said lubricant to said inorganic salt is within the range of 0.1 to 4.0.

18. The method of manufacturing metal wire rod for use in plastic working according to claim 17, wherein the solid matter weight ratio of said lubricant to said inorganic salt is within the range of 0.2 to 1.5.

19. The method of manufacturing metal wire rod for use in plastic working of claim 13, wherein the at least one cleaning process is selected from the group consisting of shot blasting, sand blasting, bending, anodic pickling, and cathodic pickling.

20. The method of manufacturing metal wire rod for use in plastic working of claim 13, wherein said metal wire rod is metal selected from the group consisting of iron, steel, stainless steel, aluminum, aluminum alloy, magnesium, magnesium alloy, titanium, titanium alloy, copper, and copper alloy.
